(19) United States
(12) Patent Application Publication
(10) Pub. No.: US 2024/0381219 A1
(43) Pub. Date: Nov. 14, 2024

(54) USER EQUIPMENT ROUTE SELECTION POLICY RULES FOR MULTI-ACCESS PROTOCOL DATA UNIT SESSIONS

(71) Applicant: QUALCOMM Incorporated, San Diego, CA (US)

(72) Inventors: Dario Serafino TONESI, San Diego, CA (US); Waqar ZIA, Munich (DE); Stefano FACCIN, San Ysidro, CA (US); Sebastian SPEICHER, Wallisellen (CH); Haris ZISIMOPOULOS, London (GB); Ajith Tom PAYYAPPILLY, San Diego, CA (US); Amer CATOVIC, San Diego, CA (US); Lenaig Genevieve CHAPONNIERE, La Jolla, CA (US)

(21) Appl. No.: 18/683,498

(22) PCT Filed: Sep. 8, 2022
(86) PCT No.: PCT/US2022/076102

§ 371 Date: Feb. 13, 2024

(30) Foreign Application Priority Data
Oct. 11, 2021 (GR) 20210100691

(51) Int. Cl. H04W 40/24; H04W 40/02

(52) U.S. Cl. CPC H04W 40/24; H04W 40/026

(57) ABSTRACT

Various aspects of the present disclosure generally relate to wireless communication. In some aspects, a user equipment (UE) may receive, from a network device, a UE route selection policy (URSP) rule that indicates a preference for a multi-access protocol data unit (PDU) session and a preferred quantity and preferred types of access links for the multi-access PDU session. The UE may establish the multi-access PDU session using the preferred quantity and the preferred types of access links indicated by the URSP rule. Numerous other aspects are described.

### CROSS-REFERENCE TO RELATED APPLICATION

This Patent Application claims priority to Greek Nonprovisional Patent Application No. 20210100691, filed on Oct. 11, 2021, entitled “USER EQUIPMENT ROUTE SELECTION POLICY RULES FOR MULTI-ACCESS PROTOCOL DATA UNIT SESSIONS,” which is hereby expressly incorporated by reference herein.

### FIELD OF THE DISCLOSURE

Aspects of the present disclosure generally relate to wireless communication and to techniques and apparatuses for user equipment (UE) route selection policy (URSP) rules for multi-access (MA) protocol data unit (PDU) sessions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to receive, from a network device, a UE route selection policy (URSP) rule that indicates a preference for a multi-access protocol data unit (PDU) session and a preferred quantity and preferred types of access links for the multi-access PDU session. The one or more processors may be configured to establish the multi-access PDU session using the preferred quantity and the preferred types of access links indicated by the URSP rule.

Some aspects described herein relate to a network device for wireless communication. The network device may include a memory and one or more processors coupled to the memory. The one or more processors may be configured to select a URSP rule for a UE, wherein the URSP indicates a preference for a multi-access PDU session and a preferred quantity and preferred types of access links for the multi-access PDU session. The one or more processors may be configured to transmit the URSP rule to the UE.

Some aspects described herein relate to a method of wireless communication performed by a UE. The method may include receiving, from a network device, a URSP rule that indicates a preference for a multi-access PDU session and a preferred quantity and preferred types of access links for the multi-access PDU session. The method may include establishing the multi-access PDU session using the preferred quantity and the preferred types of access links indicated by the URSP rule.

Some aspects described herein relate to a method of wireless communication performed by a network device. The method may include selecting a URSP rule for a UE, wherein the URSP rule indicates a preference for a multi-access PDU session and a preferred quantity and preferred types of access links for the multi-access PDU session. The method may include transmitting the URSP rule to the UE.

Some aspects described herein relate to a non-transitory computer-readable medium that stores a set of instructions for wireless communication by a UE. The set of instructions, when executed by one or more processors of the UE, may cause the UE to receive, from a network device, a URSP rule that indicates a preference for a multi-access PDU session and a preferred quantity and preferred types of access links for the multi-access PDU session. The set of instructions, when executed by one or more processors of the UE, may cause the UE to establish the multi-access PDU session using the preferred quantity and the preferred types of access links indicated by the URSP rule.

Some aspects described herein relate to a non-transitory computer-readable medium that stores a set of instructions for wireless communication by a network device. The set of instructions, when executed by one or more processors of the network device, may cause the network device to select a URSP rule for a UE, wherein the URSP indicates a preference for a multi-access PDU session and a preferred quantity and preferred types of access links for the multi-access PDU session. The set of instructions, when executed by one or more processors of the network device, may cause the network device to transmit the URSP rule to the UE.

Some aspects described herein relate to an apparatus for wireless communication. The apparatus may include means for receiving, from a network device, a URSP rule that indicates a preference for a multi-access PDU session and a preferred quantity and preferred types of access links for the multi-access PDU session. The apparatus may include means for establishing the multi-access PDU session using the preferred quantity and the preferred types of access links indicated by the URSP rule.

Some aspects described herein relate to an apparatus for wireless communication. The apparatus may include means for selecting a URSP rule for a UE, wherein the URSP indicates a preference for a multi-access PDU session and a preferred quantity and preferred types of access links for the multi-access PDU session. The apparatus may include means for transmitting the URSP rule to the UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples. those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a core network, in accordance with the present disclosure.

FIGS. 4-6 are diagrams illustrating examples associated with UE route selection policy (URSP) rules for multi-access (MA) protocol data unit (PDU) sessions, in accordance with the present disclosure.

FIGS. 7-8 are diagrams illustrating example processes associated with URSP rules for MA PDU sessions, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

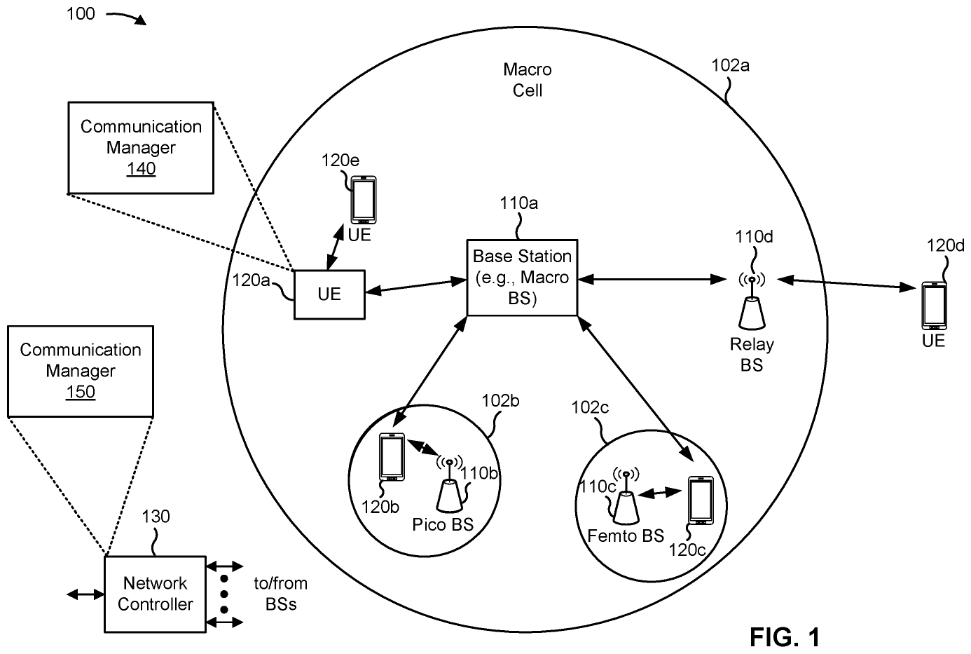

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1. the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network device, a UE route selection policy (URSP) rule that indicates a preference for a multi-access (MA) protocol data unit (PDU) session and a preferred quantity and preferred types of access links for the MA PDU session; and establish the MA PDU session using the preferred quantity and the preferred types of access links indicated by the URSP rule. Additionally, or alternatively, the communication manager 140 may perform one or more other operations described herein.

In some aspects, the network controller 130 may include a communication manager 150. As described in more detail elsewhere herein, the communication manager 150 may select a URSP rule for a UE, wherein the URSP rule indicates a preference for an MA PDU session and a preferred quantity and preferred types of access links for the MA PDU session; and transmit the URSP rule to the UE. Additionally, or alternatively, the communication manager 150 may perform one or more other operations described herein.

As indicated above, FIG. 1 is provided as an example. Other examples may differ from what is described with regard to FIG. 1.

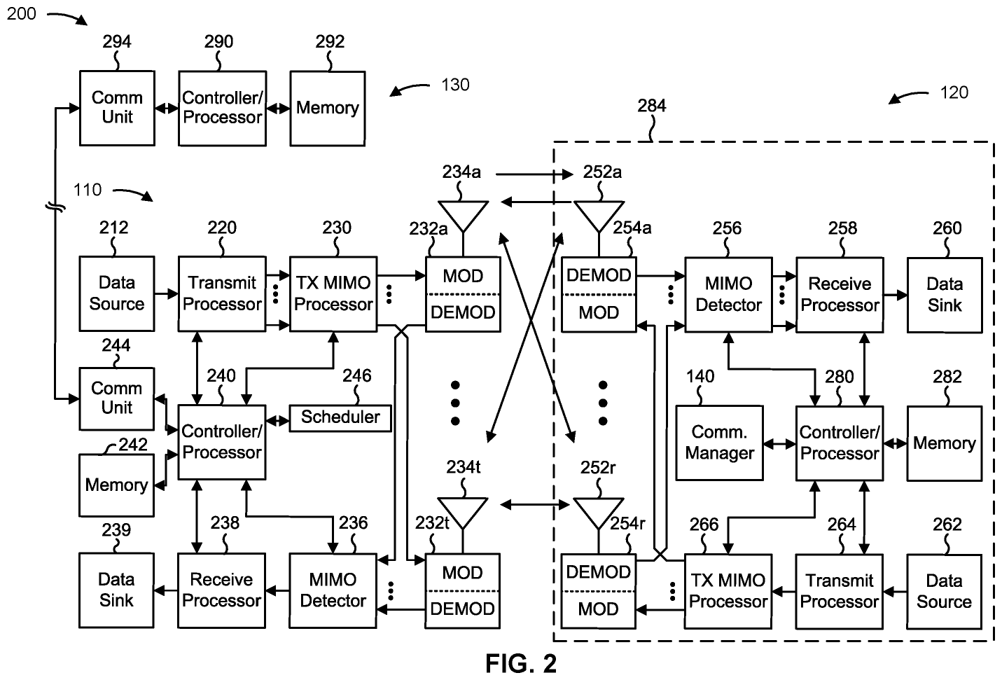

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

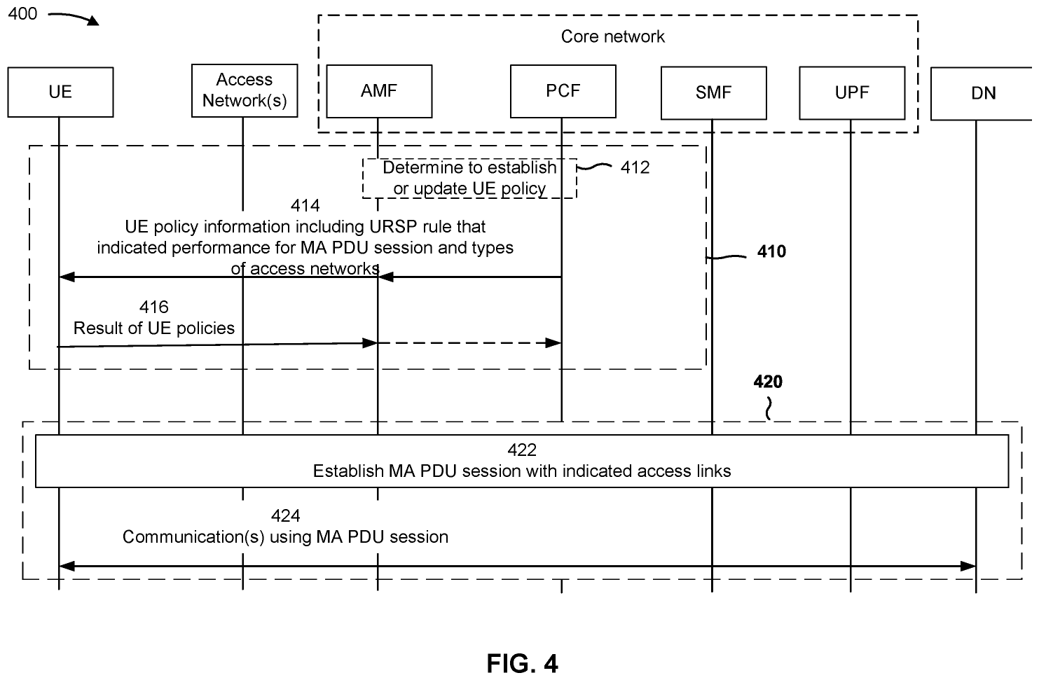

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

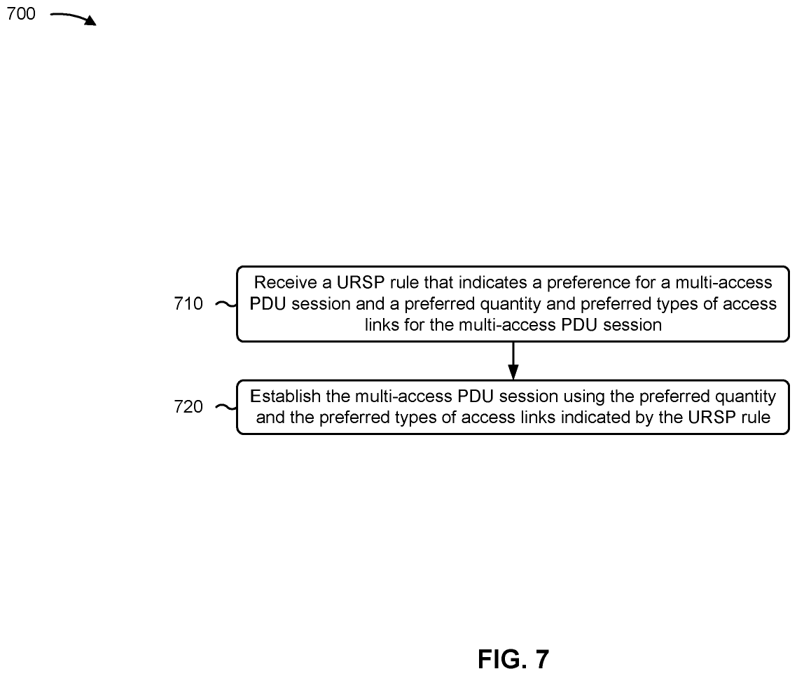

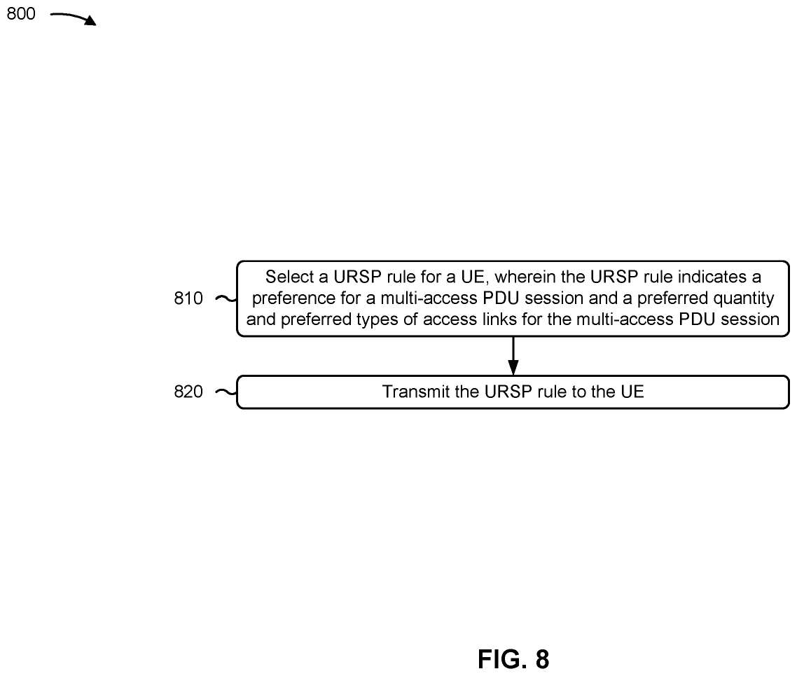

The controller/processor 240 of the base station 110, the controller/processor 280 of the UE 120, the controller/processor 290 of the network controller 130, and/or any other component(s) of FIG. 2 may perform one or more techniques associated with URSP rules for MA PDU sessions, as described in more detail elsewhere herein. For example, the controller/processor 240 of the base station 110, the controller/processor 280 of the UE 120, the controller/processor 290 of the network controller 130, and/or any other component(s) of FIG. 2 may perform or direct operations of, for example, process 700 of FIG. 7, process 800 of FIG. 8, and/or other processes as described herein. The memory 242, the memory 282, and the memory 292 may store data and program codes for the base station 110, the UE 120, and the network controller 130, respectively. In some examples, the memory 242, the memory 282, and/or the memory 292 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110, the UE 120, and/or the network controller 130 may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples. In some aspects, the network device described herein is the network controller 130, in included in the network controller 130, or includes one or more components of the network controller 130 shown in FIG. 2. In some aspects, the network device described herein is the base station 110, is included in the base station 110, or includes one or more components of the base station 110 shown in FIG. 2.

In some aspects, the UE 120 includes means for receiving, from a network device, a URSP rule that indicates a preference for an MA PDU session and a preferred quantity and preferred types of access links for the MA PDU session; and/or means for establishing the MA PDU session using the preferred quantity and the preferred types of access links indicated by the URSP rule. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network device includes means for selecting a URSP rule for a UE, wherein the URSP rule indicates a preference for an MA PDU session and a preferred quantity and preferred types of access links for the multi-access PDU session; and/or means for transmitting the URSP rule to the UE. In some aspects, the means for the network device to perform operations described herein may include, for example, one or more of communication manager 150, communication unit 294, controller/processor 290, or memory 292. In some aspects, the means for the network device to perform operations described herein may include, for example, one or more of transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

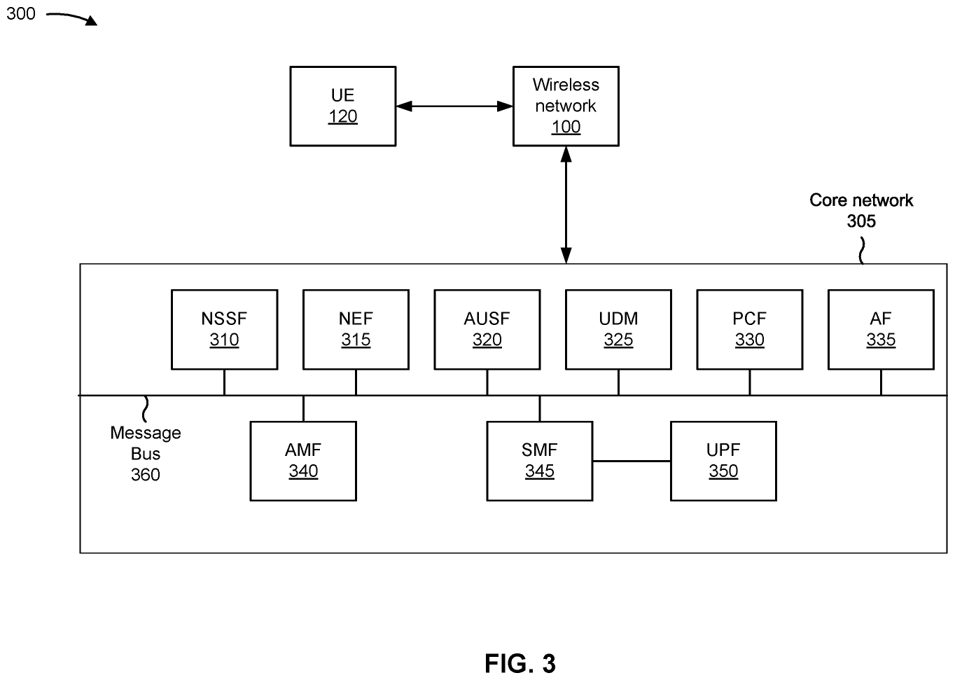

FIG. 3 is a diagram of an example 300 of a core network 305, in accordance with the present disclosure. As shown in FIG. 3, example 300 may include a UE (e.g., UE 120), a wireless communication network 100, and a core network 305. Devices and/or networks of example 300 may interconnect via wired connections, wireless connections, or a combination thereof.

The wireless communication network 100 may support, for example, a cellular RAT. The network 100 may include one or more base stations (e.g., base station 110) and other network entities that can support wireless communication for the UE 120. The network 100 may transfer traffic between the UE 120 (e.g., using a cellular RAT), one or more base stations (e.g., using a wireless interface or a backhaul interface, such as a wired backhaul interface), and/or the core network 305. The network 100 may provide one or more cells that cover geographic areas. In some examples, the wireless communication network 100 may be a radio access network (RAN). In some examples, the wireless communication network may be a 3GPP access network, such as 5G (e.g., NR) network, a 4G (e.g., LTE) network, or an evolved universal terrestrial radio access network (E-UTRAN).

In some aspects, the network 100 may perform scheduling and/or resource management for the UE 120 covered by the network 100 (e.g., the UE 120 covered by a cell provided by the network 100). In some aspects, the network 100 may be controlled or coordinated by a network controller (e.g., network controller 130 of FIG. 1), which may perform load balancing, network-level configuration, and/or the like. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, and/or network management functions (e.g., for uplink, downlink, and/or sidelink communications of the UE 120 covered by the network 100).

In some aspects, the core network 305 may include an example functional architecture in which systems and/or methods described herein may be implemented. For example, the core network 305 may include an example architecture of a 5G Next Generation (NG) core network included in a 5G wireless telecommunications system. Although the example architecture of the core network 305 shown in FIG. 3 may be an example of a service-based architecture, in some aspects, the core network 305 may be implemented as a reference-point architecture, a 4G core network, and/or the like.

As shown in FIG. 3, the core network 305 may include a number of functional elements. The functional elements may include, for example, a network slice selection function (NSSF) 310, a network exposure function (NEF) 315, an authentication server function (AUSF) 320, a unified data management (UDM) component 325, a policy control function (PCF) 330, an application function (AF) 335, an access and mobility management function (AMF) 340, a session management function (SMF) 345, and/or a user plane function (UPF) 350. These functional elements may be communicatively connected via a message bus 360. Each of the functional elements shown in FIG. 3 may be implemented on one or more devices associated with a wireless telecommunications system. In some examples, one or more of the functional elements may be implemented on physical devices, such as an access point, a base station, a gateway, and/or a network controller (e.g., network controller 130), among other examples. In some examples, one or more of the functional elements may be implemented on a computing device of a cloud computing environment.

The NSSF 310 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120.

The NEF 315 may include one or more devices that support exposure of capabilities and/or events in the wireless telecommunications system to help other entities in the wireless telecommunications system discover network services. The AUSF 320 may include one or more devices that act as an authentication server and support the process of authenticating the UE 120 in the wireless telecommunications system.

The UDM 325 may include one or more devices that store user data and profiles in the wireless telecommunications system. In some aspects, the UDM 325 may be used for fixed access and/or mobile access in the core network 305.

The PCF 330 may include one or more devices that provide a policy framework that incorporates network slicing, roaming, packet processing, and/or mobility management, among other examples.

The AF 335 may include one or more devices that support application influence on traffic routing, access to the NEF 315, and/or policy control, among other examples. The AMF 340 may include one or more devices that act as a termination point for non-access stratum (NAS) signaling and/or mobility management, among other examples.

The SMF 345 may include one or more devices that support the establishment, modification, and release of communication sessions in the wireless telecommunications system. For example, the SMF 345 may configure traffic steering policies at the UPF 350 and/or enforce user equipment Internet Protocol (IP) address allocation and policies, among other examples.

The UPF 350 may include one or more devices that serve as an anchor point for intraRAT and/or interRAT mobility. In some aspects, the UPF 350 may apply rules to packets, such as rules pertaining to packet routing, traffic reporting, and/or handling user plane quality of service (QoS), among other examples.

The message bus 360 may be a logical and/or physical communication structure for communication among the functional elements. Accordingly, the message bus 360 may permit communication between two or more functional elements, whether logically (e.g., using one or more application programming interfaces (APIs) and/or the like) and/or physically (e.g., using one or more wired and/or wireless connections).

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example 300 may perform one or more functions described as being performed by another set of devices of example environment 300.

As indicated above, FIG. 3 is provided as an example. Other examples may differ from what is described with regard to FIG. 3.

In 5G/NR, a “PDU session” is a logical connection that provides end-to-end user plane connectivity between a UE and a data network (DN) through the 5G core network (e.g., through the UPF). In some examples, different PDU sessions may be used for different applications on the UE 120. A PDU session may support one or more QoS flows. In some examples, a PDU session may be associated with a network slice (e.g., identified by single-network slice selection assistance information (S-NSSAI)) and a data network (e.g., identified by a data network name (DNN)).

Access traffic steering, switching and splitting (ATSSS) is a network capability that allows traffic steering across multiple accesses (e.g., multiple access links) at a finer granularity than a PDU session. In some examples, ATSSS has enabled MA PDU sessions with one 3GPP access and one non-3GPP access. 3GPP access refers to access to a core network (e.g., a 5G core network) via a 3GPP access network. A 3GPP access network may refer to a 5G/NR RAN, a 4G/LTE RAN, an E-UTRAN, and/or a RAN associated with a RAT subsequent to 5G (e.g., 6G). A 3GPP access link refers to an access link in a 3GPP access network. A 3GPP access network may have one or more 3GPP access links. A non-3GPP access refers to access using a non-3GPP access network (e.g., an access network other than a 3GPP access network). For example, a non-3GPP access network may be a wireless local area network (WLAN), a Wi-Fi network, or a wireline access network. A non-3GPP (e.g., a WLAN) access network may be considered a trusted non-3GPP access network or an untrusted non-3GPP access network. A non-3GPP access link refers to an access link in a non-3GPP access network. A non-3GPP access network may have one or more non-3GPP access links. In some examples, when a UE establishes an MA PDU session with one 3GPP access and one non-3GPP access, either of the 3GPP access or the non-3GPP access, or both of the 3GPP access and the non-3GPP access can be active at a given time for an application on the UE.

Currently, in 5G/NR, only MA PDU sessions with one 3GPP access and one non-3GPP access are supported. However, MA PDU sessions with multiple 3GPP accesses may be beneficial for UEs and for network traffic management. For example, an MA PDU session that allows an application on a UE to simultaneously use two 3GPP accesses from different public land mobile networks (PLMNs) and/or stand-alone non-public networks (SNPNs) with a single set of credentials may boost coverage and traffic capacity for the UE, and may improve network resource sharing. In addition, an MA PDU session that accesses an evolved packet core (EPC) via a 4G/LTE access network and accesses a 5G core via a 5G/NR access network may boost the traffic capacity for the UE, without requiring a costly upgrade of an LTE node. Furthermore, supporting MA PDU sessions using more than two access links may increase coverage and traffic capacity for UEs.

Some techniques and apparatuses described herein enable a UE to receive, from a network device (e.g., a device in the core network), a URSP rule that indicates a preference for an MA PDU session and preferred types of access links for the MA PDU session. The UE may establish the MA PDU session (e.g., for traffic associated with an application of the UE) using the preferred types of access links indicated by the URSP rule. In some aspects, the URSP rule may indicate a quantity of access links and the types of the access links to be used for the MA PDU session. In some aspects, the types of access links indicated may include multiple 3GPP access links or multiple non-3GPP access links. In some aspects, the quantity of access links indicated may be greater than two. As a result, the UE may establish an MA PDU session using multiple 3GPP access links and/or three (or more) access links, which may increase the coverage and/or reliability for an application on the UE and/or increase the traffic capacity for traffic transmitted and/or received by the application on the UE.

FIG. 4 is a diagram illustrating an example 400 associated with URSP rules for MA PDU sessions, in accordance with the present disclosure. As shown in FIG. 4, example 400 includes communication between a UE (e.g., UE 120), one or more access networks, a core network (e.g., core network 305), and a data network. An access network includes one or more access links. For example, each access network, of the one or more access networks, may include one or more access links. The core network may include one or more network devices, such as an AMF device (e.g., AMF 340), a PCF device (e.g., PCF 330), an SMF device (e.g., SMF 345), and a UPF device (e.g., UPF 350), among other examples.

In some aspects, the one or more access links of the one or more access networks may include one or more RANs. In some aspects, the one or more access links (e.g., the one or more RANs) may include one or more 3GPP access links (e.g., one or more 5G/NR RANs and/or 4G/LTE RANs) including, for example, one or more base stations (e.g., base station 110). Additionally, or alternatively, the one or more access links may include one or more non-3GPP access links, such as one or more trusted non-3GPP access networks, one or more non-trusted non-3GPP access network, and/or one or more wireline access networks, among other examples.

In some aspects, the core network and one or more of the access networks may be part of a wireless network (e.g., wireless network 100), such as a PLMN or an SNPN. In some aspects, the core network and one or more of the access networks may be part of a PLMN, and one or more of the access networks may be part of an SNPN. In some aspects, the core network and one or more of the access networks may be part of a first PLMN and one or more of the access networks may be part of a second PLMN.

As shown in FIG. 4, example 400 may include a first phase 410 and a second phase 420. The first phase 410 may be a URSP rule provisioning phase, in which the PCF communicates with the UE (e.g., via the AMF) to provision URSP rules to the UE. The second phase 420 may be a phase associated with communication between the UE and the DN, in which an MA PDU session is established and used for communications between the UE and the DN.

In the first phase 410, as shown in FIG. 4 by reference number 412, the PCF may determine to establish or update of a UE policy associated with the UE. In some aspects, the UE policy may include a URSP that includes one or more URSP rules that specify UE access selection and PDU session selection related policy information. In some aspects, the PCF may detect that a trigger condition associated with establishing or updating the UE policy has been met, and the PCF may establish or update the UE policy based at least in part on detecting that the trigger condition has occurred.

In some aspects, the trigger condition may be associated with an initial registration of the UE with the network. In this case, the UE may transmit a registration request to an access network (e.g., a base station). The access network may select an AMF and transmit the registration request to the AMF. The AMF may transmit, to the PCF, a request to establish a UE Policy associated with the PCF (e.g., Npcf_UEPolicyControl_Create Request). The request from the AMF may include a UE policy container associated with the UE, and the UE policy container may include a list of policy section identifiers (PSIs). In some aspects, the PCF may detect the trigger condition based at least in part on a determination, from the PSIs, that the UE access selection and PDU session selection related policy information associated with the UE has to be updated. In some aspects, the PCF may detect a trigger condition associated with a network triggered policy update based at least in part on a change of the UE location or a change of subscribed network slices (e.g., network slice selection assistance information (NSSAI)) for the UE.

When the PCF detects that a trigger condition has occurred, the PCF may establish and/or update the URSP for the UE. In some aspects, the PCF may select one or more URSP rules for the UE. In some aspects, a URSP rule may include a precedence value that identifies a precedence of the URSP rule among all existing URSP rules for the UE, a traffic descriptor that identifies the traffic (or traffic type) to which the URSP rule applies, and a list of one or more route selection descriptors. A route selection descriptor may include a precedence value that indicates a precedence of the route selection descriptor with respect to the other route selection descriptors and one or more route selection descriptor components. The route selection descriptor components may indicate a PDU session type and other access and PDU session policy information. Different route selection descriptor components may be included in the URSP rule (e.g., in a route selection descriptor) for different PDU sessions. In some aspects, each route selection descriptor component may be associated with a respective route selection descriptor component type identifier that precedes the route selection descriptor component in the contents of the route selection descriptor. For example, a route selection descriptor component may be encoded as a sequence of a one octet route selection descriptor type identifier and a route selection descriptor value field.

In some aspects, the PCF may select, for the UE (e.g., for traffic associated with an application on the UE) a URSP rule that indicates a preference for an MA PDU session. In some aspects, the URSP rule may include a route selection descriptor component that indicates the preference for the MA PDU session. For example, the route selection descriptor component that indicates the preference for the MS PDU session may be referred to as a “multi-access preference type” route selection descriptor component. In some aspects, the route selection descriptor value field associated with the “multi-access preference type” route selection descriptor may be of zero length. In this case, the “multi-access preference type” route selection descriptor component may be encoded as the route selection descriptor component type identifier associated with the “multi-access preference type” route selection descriptor component, without a subsequent route selection descriptor value field. That is, the presence of the route selection descriptor component type identifier associated with the “multi-access preference type” route selection descriptor component may provide the indication of the preference for the MA PDU session.

In some aspects, the URSP (e.g., selected by the PCF) may indicate preferred types of accesses (e.g., preferred types of access links) for the MA PDU session. In some aspects, the URSP may include a route selection descriptor component that indicates the preferred types of accesses for the MA PDU session. The route selection descriptor component that indicates the preferred types of accesses for the MA PDU session may be referred to as a “multi-access preferred access types type” route selection descriptor component. In some aspects, the “multi-access preferred access types type” route selection descriptor component value field may be encoded as a one octet (e.g., 8 bits) multi-access preferred access types field. The multi-access preferred access types field (e.g., the route selection descriptor component value field) may indicate a multi-access access type option from a plurality of multi-access access type options that are associated with different quantities and types of access links for the MA PDU session. In this case, the value of the multiple access preferred access types field may provide an indication of the quantity and types of accesses for the MA PDU session (e.g., corresponding to a selected multi-access access type option from the plurality of multi-access access type options).

In some aspects, the plurality of multi-access access type options may include one or more options that include multiple 3GPP accesses, one or more options that include multiple non-3GPP accesses, and/or one or more options that include more than two accesses. For example, the plurality of multi-access access type options may include a first multi-access access type option associated with two 3GPP access links, a second multi-access access type option associated with two non-3GPP access links, a third multi-access access type option associated with three 3GPP access links, a fourth multi-access access type option associated with two 3GPP access links and one non-3GPP access links, a fifth multi-access access type option associated with one 3GPP access links and two non-3GPP access links, and a sixth multi-access access type option associated with three non-3GPP access links. Each multi-access access type option in the plurality of multi-access access type options may be encoded using a respective value in the multi-access preferred access types field. In some aspects, a subset of the bits (e.g., bits 3 to 1) in the multi-access preferred access types field may be used to indicate the selected multi-access access type option, and the remaining bits (e.g., bits 8 to 4) may be spare.

In some aspects, the PCF may include the “multi-access preferred access types type” route selection descriptor component in the route selection descriptor of the URSP rule only if the “multi-access preference type” route selection descriptor component is included (e.g., only if the URSP rule indicates the preference for the MS PDU session). In some aspects, if the “multi-access preference type” route selection descriptor component is included in the route selection descriptor of the URSP rule (e.g., if the “multi-access preference type” route selection description component identifier is present), and the “multi-access preferred access types type” route selection descriptor component is not present in the route selection descriptor of the URSP rule, the preferred access types for the MA PDU session may be default access types. For example, the default access types for the MA PDU session may be one 3GPP access and one non-3GPP access. In this case, the PCF may indicate the default access types (e.g., one 3GPP access and one non-3GPP access) for the MA PDU session by including the route selection descriptor that indicates the preference for the MA PDU session without including the route selection descriptor that indicates the preferred access types for the MA PDU session.

In some aspects, in addition to or instead of indicating the default access types (e.g., one 3GPP access and one non-3GPP access) by including the “multi-access preference type” route selection descriptor component without the “multi-access preferred access types type” route selection descriptor component, the default access types (e.g., one 3GPP access and one non-3GPP access) for the MA PDU session may be indicated with an explicit indication of a value associated with the default access types in the multi-access preferred access types field (e.g., the route selection descriptor component value field associated with “multi-access preferred access types type” route selection descriptor component). In this case, the plurality of multi-access access type options may include a first multi-access access type option associated with two 3GPP access links, a second multi-access access type option associated with two non-3GPP access links, a third multi-access access type option associated with three 3GPP access links, a fourth multi-access access type option associated with two 3GPP access links and one non-3GPP access link, a fifth multi-access access type option associated with one 3GPP access link and two non-3GPP access links, a sixth multi-access access type option associated with three non-3GPP access links, and a seventh multi-access access type option associated with one 3GPP access link and one non-3GPP access link. Each multi-access access type option in the plurality of multi-access access type options may be encoded using a respective value in the multi-access preferred access types field.

As further shown in FIG. 4. and by reference number 414. the PCF may transmit. to the UE. the UE policy including the URSP rule that indicates the preference for the MA PDU session and the preferred access types for the MA PDU session. In some aspects. the PCF may transmit the UE policy to the UE via the AMF. For example. the PCF may invoke a message transfer service operation (e.g., Namf_Communication_N1N2MessageTransfer) provided by the AMF to transmit a UE policy container including one or more URSP rules for the UE (e.g., including the URSP rule that indicates the preference for the MA PDU session and the preferred access types for the MA PDU session) to the UE. In this case. the AMF may forward the UE policy container to the UE. For example. the AMF may transfer the UE Policy container to the UE via an access network, such as 3GPP access network or non-3GPP access network.

As further shown in FIG. 4, and by reference number 416, the UE may transmit, to the AMF, results of the UE policy provided by the PCF. The UE may receive the UE policy provided by the PCF, and the UE may update stored UE policy information for the UE with the UE policy information included in the UE policy provided by the PCF. The UE, in connection with updating the UE policy information. may transmit results of updating the UE policy information to the AMF. For example, the results of updating the UE policy information may provide an indication of whether all of the policy sections in the UE policy information were successfully updated and stored by the UE. In some aspects, the AMF may forward the results, received from the UE, to the PCF (e.g., using a Namf_N1MessageNotify message).

In some cases, such as if the UE is registered with multiple PLMNs, the UE may receive respective URSP rules from multiple PLMNs. In this case, the UE may use the URSP rules of the primary PLMN.

In this second phase 420, as shown by reference number 422, the UE may establish the MA PDU session using the preferred types of access links indicated by the URSP rule in the UE policy. In some aspects, the UE may establish the MA PDU using the preferred types of access links indicated by the URSP rule in the UE policy based at least in part on determining that traffic associated with an application on the UE matches the traffic descriptor included in the URSP rule. For example, the traffic that matches the traffic descriptor included in the URSP rule may trigger the URSP rule. The UE, in connection with triggering the URSP rule, may determine that the URSP rule indicates the preference for the MA PDU session. For example, the UE may determine that the “multi-access preference” route selection descriptor component is included in the route selection descriptor of the URSP rule. The UE may then determine the preferred access types indicated for the MA PDU session. In some aspects, the UE may determine that the “multi-access preferred access types type” route selection descriptor component is included in the route selection descriptor for the URSP rule, and route selection descriptor component field value associated with the multi-access preferred access types type” route selection descriptor component may indicate the quantity and the types of the access links for the MA PDU session (e.g., corresponding to an indicated multi-access access type option from the plurality of multi-access access type options). In some aspects, the UE may determine to use default access types (e.g., one 3GPP access and one non-3GPP access) in connection with a determination that the route selection descriptor of the URSP rule includes the “multi-access preference” route selection descriptor component, but does not include the “multi-access preferred access types type” route selection descriptor component.

In some aspects, the UE, to establish the MA PDU session, may transmit a PDU session establishment request to the AMF (e.g., via an access network). The AMF may forward the PDU session establishment request to the SMF. The SMF, based at least in part on the PDU session establishment request, may select the UPF, create the MA PDU session, and manage the MA PDU session. The MA PDU session may provide end-to-end user plane connectivity between the UE (e.g., via the indicated types of accesses) and the DN through the UPF.

In some aspects, according to the indicated preferred access types in the URSP rule, the MA PDU session may use multiple 3GPP accesses. In some aspects, the MA PDU session may use multiple 3GPP accesses from different PLMNs and/or SNPNs. For example, the MA PDU session may use a first 3GPP access associated with a first PLMN and a second 3GPP access associated with a second PLMN or an SNPN. This may result in boosting capacity and/or coverage for the traffic/application associated with the MA PDU session. In some aspects, the UE (e.g., the application on the UE may access the multiple 3GPP accesses associated with different PLMNs and/or SNPNs using a single set of credentials.

In some aspects, in a case in which the MA PDU session uses multiple 3GPP accesses, the UE may access an EPC network via a first 3GPP access (e.g., a 4G/LTE base station) and the UE may access a 5G core network via a second 3GPP access (e.g., a 5G/NR base station). This may result in in boosting capacity for the traffic/application associated with the MA PDU session. In this case, the first and second 3GPP accesses may be included in a single PLMN, different PLMNs (e.g., a first PLMN and a second PLMN, respectively) or a PLMN and an SNPN. In some aspects. a common UPF and packet gateway user plane function (PFW-U) may aggregate the traffic from the first and second 3GPP accesses.

In some aspects, in a case in which the MA PDU session uses multiple 3GPP access links, the multiple 3GPP accesses may include a 3GPP terrestrial access network and a 3GPP non-terrestrial access network (e.g., via a satellite or an unmanned aerial vehicle (UAV)). In this case, even if the non-terrestrial (e.g., satellite) access is deployed by the same PLMN as the terrestrial access, the QoS over the two accesses may be quite different, with the respective QoS for each access fluctuating. In addition, the non-terrestrial (e.g., satellite) access and the terrestrial access may have different PLMN identifiers (IDs) (e.g., the satellite access may use mobile country code (MCC) 9xx configured as an equivalent PLMN to terrestrial access PLMN ID). The use of the MA PDU with the terrestrial 3GPP access and the non-terrestrial 3GPP access may provide service in locations where terrestrial networks are not deployed, a smooth switch between non-terrestrial and terrestrial networks, and/or a capacity boost when both networks are available.

In some aspects, according to the indicated preferred access types in the URSP rule, the PDU session may use multiple non-3GPP accesses. In some implementations, according to the indicated preferred access types in the URSP rule, the PDU session may use more than two accesses. In a case in which the MA PDU session uses a non-3GPP access link, the non-3GPP access link may be associated with a trusted non-3GPP access network, an untrusted non-3GPP access network, or a wireline access network. In some aspects, each of one or more trusted non-3GPP access networks may be connected to the core network (e.g., the 5G core network via a trusted non-3GPP gateway function (TNGF). In some aspects, each of one or more untrusted non-3GPP access networks may be connected to the core network (e.g., the 5G core network) via a non-3GPP interworking function (N3IWF).

As further shown in FIG. 4, and by reference number 424, the UE may transmit one or more communications to the DN and/or receive one or more communications from the DN using the MA PDU session. In some aspects, the MA PDU session may use multiple access links, such as one or more 3GPP access links and/or one or more non-3GPP access links. In some aspects, at a given time, the UE may transmit or receive communications via any one of the multiple access links associated with the MA PDU session or via any combination of the multiple access links associated with the MA PDU session.

As described above, the UE may receive, from a network device (e.g., in the core network), a URSP rule that indicates a preference for an MA PDU session and preferred types of access links for the MA PDU session. The UE may establish the MA PDU session (e.g., for traffic associated with an application of the UE) using the preferred types of access links indicated by the URSP rule. In some aspects, the URSP rule may indicate a quantity of access links and the types of the access links to be used for the MA PDU session. In some aspects, the types of access links indicated may include multiple 3GPP access links or multiple non-3GPP access links. In some aspects, the quantity of access links indicated may be greater than two. As a result, the UE may establish an MA PDU session using multiple 3GPP access links and/or three (or more) access links, which may increase the coverage for an application on the UE and/or increase the traffic capacity for traffic transmitted and/or received by the application on the UE.

As indicated above, FIG. 4 is provided as an example. Other examples may differ from what is described with respect to FIG. 4.

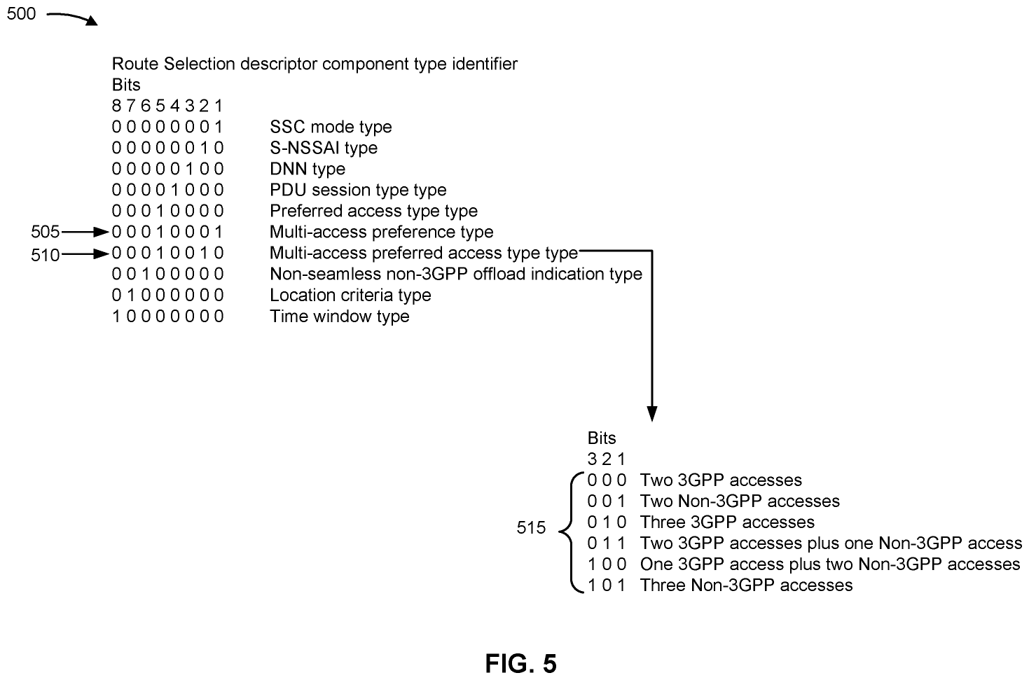

FIG. 5 is a diagram illustrating an example 500 associated with URSP rules for MA PDU sessions, in accordance with the present disclosure. As shown in FIG. 5, example 500 includes a list of route selection descriptor component type identifiers associated with route selection descriptor components that may be included in a route selection descriptor of a URSP rule.

As shown by reference number 505, in some aspects, a route selection descriptor component type identifier (e.g., 00010001) associated with a “multi-access preference type” route selection descriptor component may be used to identify the “multi-access preference type” route selection descriptor component in the route selection descriptor of the URSP rule, and to provide an indication of a preference for an MA PDU session. As shown by reference number 510, a route selection descriptor component type identifier (e.g., 00010010) associated with a “multi-access preferred access types type” route selection descriptor component may be used to identify the “multi-access preferred access types type” route selection descriptor component in the route selection descriptor of the URSP rule. In some aspects, when present in the route selection descriptor of the URSP rule, the route selection descriptor component type identifier (e.g., 00010010) associated with a “multi-access preferred access types type” route selection descriptor component may be followed by a route selection descriptor component value field associated with the “multi-access preferred access types type” route selection descriptor component. In some aspects, the component value field associated with the “multi-access preferred access types type” route selection descriptor component may be encoded as a one octet (e.g., 8 bits) multi-access preferred access types field. In some aspects, as shown in FIG. 5, a subset of the bits (e.g., bits 3 to 1) in the multi-access preferred access types field may be used to indicate the selected multi-access access type option, and the remaining bits (e.g., bits 8 to 4) may be spare.

As shown by reference number 515, different values for the multi-access preferred access types field may be associated with different quantities and/or types of accesses for an MA PDU session. For example, the different values for the multi-access preferred access types field may be associated with different multi-access access type options. As shown in FIG. 5, a first value (e.g., 000) for the multi-access preferred access types field may be associated with two 3GPP accesses, a second value (e.g., 001) for the multi-access preferred access types field may be associated with two non-3GPP accesses, a third value (e.g., 020) for the multi-access preferred access types field may be associated with three 3GPP accesses, a fourth value (e.g., 011) for the multi-access preferred access types field may be associated with two 3GPP accesses and one non-3GPP access, a fifth value (e.g., 100) for the multi-access preferred access types field may be associated with one 3GPP access and two non-3GPP accesses, and a sixth value (e.g., 101) for the multi-access preferred access types field may be associated with three non-3GPP accesses.

In some aspects, the “multi-access preferred access types type” route selection descriptor component may be included in the route selection descriptor of the URSP rule only if the “multi-access preference type” route selection descriptor component is included in the route selection descriptor component. In some aspects, if the “multi-access preference type” route selection descriptor component is included in the route selection descriptor of the URSP rule and the “multi-access preferred access types type” route selection descriptor component is not included in the route selection descriptor of the URSP rule, the preferred access types for the MA PDU session may be default access types. For example, the default access types for the MA PDU session may be one 3GPP access and one non-3GPP access.

As indicated above, FIG. 5 is provided as an example. Other examples may differ from what is described with respect to FIG. 5.

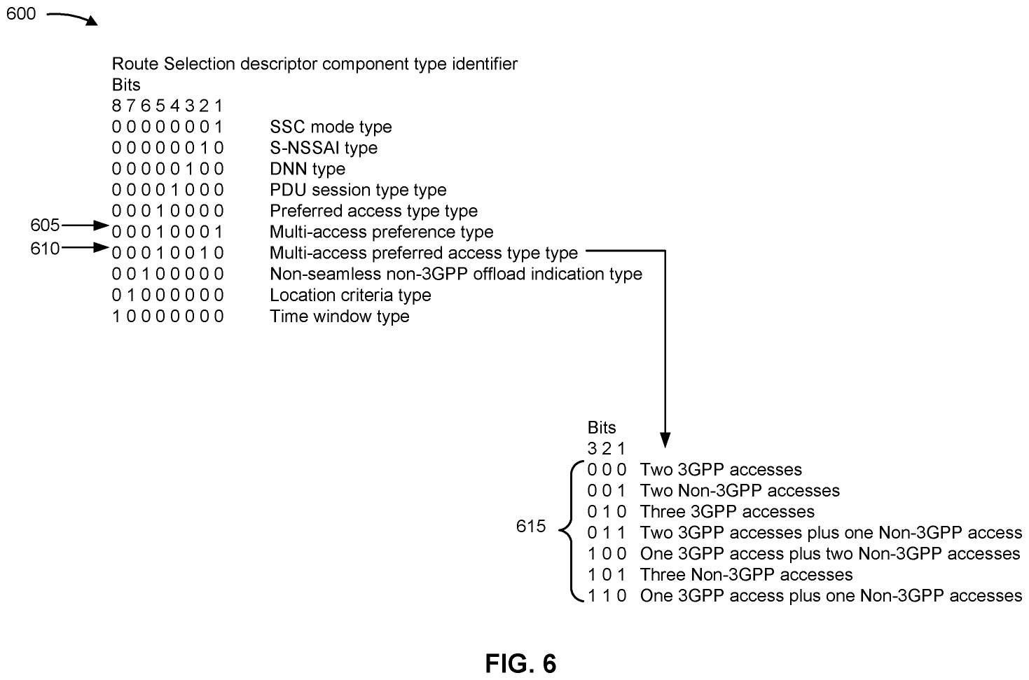

FIG. 6 is a diagram illustrating an example 600 associated with URSP rules for MA PDU sessions, in accordance with the present disclosure. As shown in FIG. 6, example 600 includes a list of route selection descriptor component type identifiers associated with route selection descriptor components that may be included in a route selection descriptor of a URSP rule.

As shown by reference number 605, in some aspects, a route selection descriptor component type identifier (e.g., 00010001) associated with a “multi-access preference type” route selection descriptor component may be used to identify the “multi-access preference type” route selection descriptor component in the route selection descriptor of the URSP rule, and to provide an indication of a preference for an MA PDU session. As shown by reference number 610, a route selection descriptor component type identifier (e.g., 00010010) associated with a “multi-access preferred access types type” route selection descriptor component may be used to identify the “multi-access preferred access types type” route selection descriptor component in the route selection descriptor of the URSP rule. In some aspects, when present in the route selection descriptor of the URSP rule, the route selection descriptor component type identifier (e.g., 00010010) associated with a “multi-access preferred access types type” route selection descriptor component may be followed by a route selection descriptor component value field associated with the “multi-access preferred access types type” route selection descriptor component. In some aspects, the component value field associated with the “multi-access preferred access types type” route selection descriptor component may be encoded as a one octet (e.g., 8 bits) multi-access preferred access types field. In some aspects, as shown in FIG. 6, a subset of the bits (e.g., bits 3 to 1) in the multi-access preferred access types field may be used to indicate the selected multi-access access type option, and the remaining bits (e.g., bits 8 to 4) may be spare.

As shown by reference number 615, different values for the multi-access preferred access types field may be associated with different quantities and/or types of accesses for an MA PDU session. For example, the different values for the multi-access preferred access types field may be associated with different multi-access access type options. As shown in FIG. 6, a first value (e.g., 000) for the multi-access preferred access types field may be associated with two 3GPP accesses, a second value (e.g., 001) for the multi-access preferred access types field may be associated with two non-3GPP accesses, a third value (e.g., 010) for the multi-access preferred access types field may be associated with three 3GPP accesses, a fourth value (e.g., 011) for the multi-access preferred access types field may be associated with two 3GPP accesses and one non-3GPP access, a fifth value (e.g., 100) for the multi-access preferred access types field may be associated with one 3GPP access and two non-3GPP accesses, a sixth value (e.g., 101) for the multi-access preferred access types field may be associated with three non-3GPP accesses, and a seventh value (e.g., 110) for the multi-access preferred access types field may be associated with one 3GPP access and one non-3GPP access.

In some aspects, the “multi-access preferred access types type” route selection descriptor component may be included in the route selection descriptor of the URSP rule only if the “multi-access preference type” route selection descriptor component is included in the route selection descriptor component. In some aspects, if the “multi-access preference type” route selection descriptor component is included in the route selection descriptor of the URSP rule and the “multi-access preferred access types type” route selection descriptor component is not included in the route selection descriptor of the URSP rule, the preferred access types for the MA PDU session may be default access types. For example, the default access types for the MA PDU session may be one 3GPP access and one non-3GPP access.

As indicated above, FIG. 5 is provided as an example. Other examples may differ from what is described with respect to FIG. 5.

FIG. 7 is a diagram illustrating an example process 700 performed, for example, by a UE, in accordance with the present disclosure. Example process 700 is an example where the UE (e.g., UE 120) performs operations associated with URSP rules for MA PDU sessions.

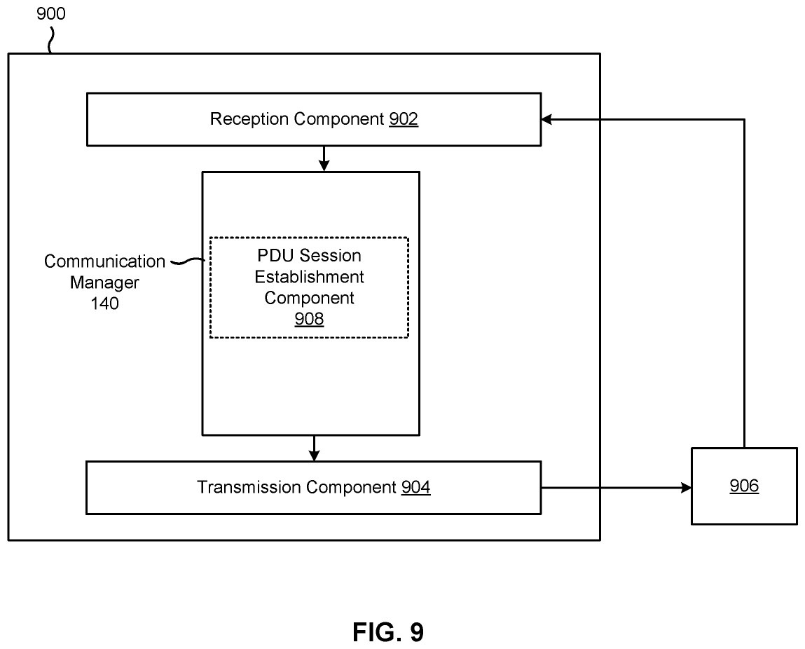

As shown in FIG. 7, in some aspects, process 700 may include receiving, from a network device, a URSP rule that indicates a preference for a multi-access PDU session and a preferred quantity and preferred types of access links for the multi-access PDU session (block 710). For example, the UE (e.g., using communication manager 140 and/or reception component 902, depicted in FIG. 9) may receive, from a network device, a URSP rule that indicates a preference for a multi-access PDU session and a preferred quantity and preferred types of access links for the multi-access PDU session, as described above.

As further shown in FIG. 7, in some aspects, process 700 may include establishing the multi-access PDU session using the preferred quantity and the preferred types of access links indicated by the URSP rule (block 720). For example, the UE (e.g., using communication manager 140 and/or PDU session establishment component 908, depicted in FIG. 9) may establish the multi-access PDU session using the preferred quantity and the preferred types of access links indicated by the URSP rule, as described above.

Process 700 may include additional aspects, such as any single aspect or any combination of aspects described below and/or in connection with one or more other processes described elsewhere herein.

In a first aspect, the URSP rule includes a route selection descriptor component that indicates the preferred quantity and the preferred types of access links for the multi-access PDU session.

In a second aspect, alone or in combination with the first aspect, the route selection descriptor component includes an indication of a multi-access access type option of a plurality of multi-access access type options that are associated with different quantities and types of access links for the multi-access PDU session.

In a third aspect, alone or in combination with one or more of the first and second aspects, the plurality of multi-access access type options includes a first multi-access access type option associated with two 3GPP access links, a second multi-access access type option associated with two non-3GPP access links, a third multi-access access type option associated with three 3GPP access links, a fourth multi-access access type option associated with two 3GPP access links and one non-3GPP access link, a fifth multi-access access type option associated with one 3GPP access link and two non-3GPP access links, and a sixth multi-access access type option associated with three non-3GPP access links.

In a fourth aspect, alone or in combination with one or more of the first through third aspects, the plurality of multi-access access type options further includes a seventh multi-access access type option associated with one 3GPP access link and one non-3GPP access link.

In a fifth aspect, alone or in combination with one or more of the first through fourth aspects, process 700 includes transmitting, to a base station, a registration request, wherein receiving the URSP rule is based at least in part on transmitting the registration request.

In a sixth aspect, alone or in combination with one or more of the first through fifth aspects, the preferred types of access links for the multi-access PDU session include multiple 3GPP access links.

In a seventh aspect, alone or in combination with one or more of the first through sixth aspects, the preferred types of access links for the multi-access PDU session include multiple non-3GPP access links.

In an eighth aspect, alone or in combination with one or more of the first through seventh aspects, the preferred quantity of access links for the multi-access PDU session include more than two access links.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network device, in accordance with the present disclosure. Example process 800 is an example where the network device (e.g., network controller 130 and/or PCF 330) performs operations associated with URSP rules for MA PDU sessions.

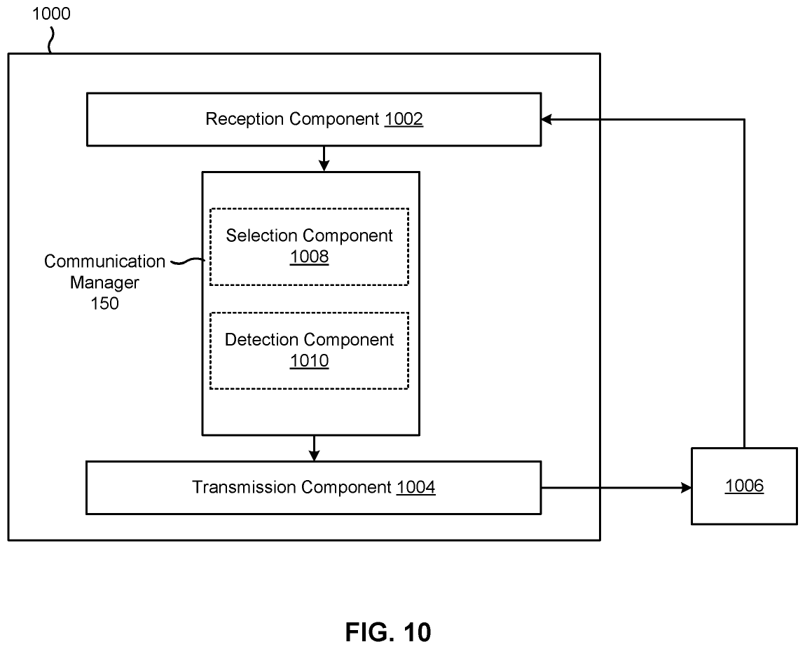

As shown in FIG. 8, in some aspects, process 800 may include selecting a URSP rule for a UE, wherein the URSP rule indicates a preference for a multi-access PDU session and a preferred quantity and preferred types of access links for the multi-access PDU session (block 810). For example, the network device (e.g., using communication manager 150 and/or selection component 1008, depicted in FIG. 10) may select a URSP rule for a UE, wherein the URSP rule indicates a preference for a multi-access PDU session and a preferred quantity and preferred types of access links for the multi-access PDU session, as described above.

As further shown in FIG. 8, in some aspects, process 800 may include transmitting the URSP rule to the UE (block 820). For example, the network device (e.g., using communication manager 150 and/or transmission component 1004, depicted in FIG. 10) may transmit the URSP rule to the UE, as described above.

Process 800 may include additional aspects, such as any single aspect or any combination of aspects described below and/or in connection with one or more other processes described elsewhere herein.

In a first aspect, the URSP rule includes a route selection descriptor component that indicates the preferred quantity and the preferred types of access links for the multi-access PDU session.

In a second aspect, alone or in combination with the first aspect, the route selection descriptor component includes an indication of a multi-access access type option of a plurality of multi-access access type options that are associated with different quantities and types of access links for the multi-access PDU session.

In a third aspect, alone or in combination with one or more of the first and second aspects, the plurality of multi-access access type options includes a first multi-access access type option associated with two 3GPP access links, a second multi-access access type option associated with two non-3GPP access links, a third multi-access access type option associated with three 3GPP access links, a fourth multi-access access type option associated with two 3GPP access links and one non-3GPP access link, a fifth multi-access access type option associated with one 3GPP access link and two non-3GPP access links, and a sixth multi-access access type option associated with three non-3GPP access links.

In a fourth aspect, alone or in combination with one or more of the first through third aspects, the plurality of multi-access access type options further includes a seventh multi-access access type option associated with one 3GPP access link and one non-3GPP access link.

In a fifth aspect, alone or in combination with one or more of the first through fourth aspects, process 800 includes detecting a trigger condition, wherein selecting the URSP rule for the UE is based at least in part on detecting the trigger condition.

In a sixth aspect, alone or in combination with one or more of the first through fifth aspects, the preferred types of access links for the multi-access PDU session include multiple 3GPP access links.

In a seventh aspect, alone or in combination with one or more of the first through sixth aspects, the preferred types of access links for the multi-access PDU session include multiple non-3GPP access links.

In an eighth aspect, alone or in combination with one or more of the first through seventh aspects, the preferred quantity of access links for the multi-access PDU session include more than two access links.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a PDU session establishment component 908.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, from a network device, a URSP rule that indicates a preference for a multi-access PDU session and a preferred quantity and preferred types of access links for the multi-access PDU session. The PDU session establishment component 908 may establish the multi-access PDU session using the preferred quantity and the preferred types of access links indicated by the URSP rule.

The transmission component 904 may transmit, to a base station, a registration request, wherein receiving the URSP rule is based at least in part on transmitting the registration request.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network device, or a network device may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include one or more of a selection component 1008 and/or a detection component 1010, among other examples.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network device described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network device described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network device described in connection with FIG. 2. In some aspects, the transmission component 1004 may be co-located with the reception component 1002 in a transceiver.

The selection component 1008 may select a URSP rule for a UE, wherein the URSP rule indicates a preference for a multi-access PDU session and a preferred quantity and preferred types of access links for the multi-access PDU session. The transmission component 1004 may transmit the URSP rule to the UE.

The detection component 1010 may detect a trigger condition, wherein selecting the URSP rule for the UE is based at least in part on detecting the trigger condition.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving, from a network device, a UE route selection policy (URSP) rule that indicates a preference for a multi-access protocol data unit (PDU) session and a preferred quantity and preferred types of access links for the multi-access PDU session; and establishing the multi-access PDU session using the preferred quantity and the preferred types of access links indicated by the URSP rule.

Aspect 2: The method of Aspect 1, wherein the URSP rule includes a route selection descriptor component that indicates the preferred quantity and the preferred types of access links for the multi-access PDU session.

Aspect 3: The method of Aspect 2, wherein the route selection descriptor component includes an indication of a multi-access access type option of a plurality of multi-access access type options that are associated with different quantities and types of access links for the multi-access PDU session.

Aspect 4: The method of Aspect 3, wherein the plurality of multi-access access type options includes a first multi-access access type option associated with two 3GPP access links, a second multi-access access type option associated with two non-3GPP access links, a third multi-access access type option associated with three 3GPP access links, a fourth multi-access access type option associated with two 3GPP access links and one non-3GPP access link, a fifth multi-access access type option associated with one 3GPP access link and two non-3GPP access links, and a sixth multi-access access type option associated with three non-3GPP access links.

Aspect 5: The method of Aspect 4, wherein the plurality of multi-access access type options further includes a seventh multi-access access type option associated with one 3GPP access link and one non-3GPP access link.

Aspect 6: The method of any of Aspects 1-5, further comprising: transmitting, to a base station, a registration request, wherein receiving the URSP rule is based at least in part on transmitting the registration request.

Aspect 7: The method of any of Aspects 1-6, wherein the preferred types of access links for the multi-access PDU session include multiple 3GPP access links.

Aspect 8: The method of any of Aspects 1-7, wherein the preferred types of access links for the multi-access PDU session include multiple non-3GPP access links.

Aspect 9: The method of any of Aspects 1-8, wherein the preferred quantity of access links for the multi-access PDU session include more than two access links.

Aspect 10: A method of wireless communication performed by a network device, comprising: selecting a user equipment (UE) route selection policy (URSP) rule for a UE, wherein the URSP rule indicates a preference for a multi-access protocol data unit (PDU) session and a preferred quantity and preferred types of access links for the multi-access PDU session; and transmitting the URSP rule to the UE.

Aspect 11: The method of Aspect 10, wherein the URSP rule includes a route selection descriptor component that indicates the preferred quantity and preferred types of access links for the multi-access PDU session.

Aspect 12: The method of Aspect 11, wherein the route selection descriptor component includes an indication of a multi-access access type option of a plurality of multi-access access type options that are associated with different quantities and types of access links for the multi-access PDU session.

Aspect 13: The method of Aspect 12, wherein the plurality of multi-access access type options includes a first multi-access access type option associated with two 3GPP access links, a second multi-access access type option associated with two non-3GPP access links, a third multi-access access type option associated with three 3GPP access links, a fourth multi-access access type option associated with two 3GPP access links and one non-3GPP access link, a fifth multi-access access type option associated with one 3GPP access link and two non-3GPP access links, and a sixth multi-access access type option associated with three non-3GPP access links.

Aspect 14: The method of Aspect 13, wherein the plurality of multi-access access type options further includes a seventh multi-access access type option associated with one 3GPP access link and one non-3GPP access link.

Aspect 15: The method of any of Aspects 10-14, further comprising: detecting a trigger condition, wherein selecting the URSP rule for the UE is based at least in part on detecting the trigger condition.

Aspect 16: The method of any of Aspects 10-15, wherein the preferred types of access links for the multi-access PDU session include multiple 3GPP access links.

Aspect 17: The method of any of Aspects 10-16, wherein the preferred types of access links for the multi-access PDU session include multiple non-3GPP access links.

Aspect 18: The method of any of Aspects 10-17, wherein the preferred quantity of access links for the multi-access PDU session include more than two access links.

Aspect 19: An apparatus for wireless communication at a device, comprising a processor; memory coupled with the processor; and instructions stored in the memory and executable by the processor to cause the apparatus to perform the method of one or more of Aspects 1-9.

Aspect 20: A device for wireless communication, comprising a memory and one or more processors coupled to the memory, the one or more processors configured to perform the method of one or more of Aspects 1-9.

Aspect 21: An apparatus for wireless communication, comprising at least one means for performing the method of one or more of Aspects 1-9.

Aspect 22: A non-transitory computer-readable medium storing code for wireless communication, the code comprising instructions executable by a processor to perform the method of one or more of Aspects 1-9.

Aspect 23: A non-transitory computer-readable medium storing a set of instructions for wireless communication, the set of instructions comprising one or more instructions that, when executed by one or more processors of a device, cause the device to perform the method of one or more of Aspects 1-9.

Aspect 24: An apparatus for wireless communication at a device, comprising a processor; memory coupled with the processor; and instructions stored in the memory and executable by the processor to cause the apparatus to perform the method of one or more of Aspects 10-18.

Aspect 25: A device for wireless communication, comprising a memory and one or more processors coupled to the memory, the one or more processors configured to perform the method of one or more of Aspects 10-18.

Aspect 26: An apparatus for wireless communication, comprising at least one means for performing the method of one or more of Aspects 10-18.

Aspect 27: A non-transitory computer-readable medium storing code for wireless communication, the code comprising instructions executable by a processor to perform the method of one or more of Aspects 10-18.

Aspect 28: A non-transitory computer-readable medium storing a set of instructions for wireless communication, the set of instructions comprising one or more instructions that, when executed by one or more processors of a device, cause the device to perform the method of one or more of Aspects 10-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a network device, a UE route selection policy (URSP) rule that indicates a preference for a multi-access protocol data unit (PDU) session and a preferred quantity and preferred types of access links for the multi-access PDU session; and
establish the multi-access PDU session using the preferred quantity and the preferred types of access links indicated by the URSP rule.

2. The UE of claim 1, wherein the URSP rule includes a route selection descriptor component that indicates the preferred quantity and the preferred types of access links for the multi-access PDU session.

3. The UE of claim 2, wherein the route selection descriptor component includes an indication of a multi-access access type option of a plurality of multi-access access type options that are associated with different quantities and types of access links for the multi-access PDU session.

4. The UE of claim 3, wherein the plurality of multi-access access type options includes a first multi-access access type option associated with two 3GPP access links, a second multi-access access type option associated with two non-3GPP access links, a third multi-access access type option associated with three 3GPP access links, a fourth multi-access access type option associated with two 3GPP access links and one non-3GPP access link, a fifth multi-access access type option associated with one 3GPP access link and two non-3GPP access links, and a sixth multi-access access type option associated with three non-3GPP access links.

5. The UE of claim 4, wherein the plurality of multi-access access type options further includes a seventh multi-access access type option associated with one 3GPP access link and one non-3GPP access link.

6. The UE of claim 1, wherein the one or more processors are further configured to:
transmit, to a base station, a registration request, wherein the one or more processors, to receive the URSP rule, are configured to receive the URSP rule based at least in part on transmitting the registration request.

7. The UE of claim 1, wherein the preferred types of access links for the multi-access PDU session include multiple 3GPP access links.

8. The UE of claim 1, wherein the preferred types of access links for the multi-access PDU session include multiple non-3GPP access links.

9. The UE of claim 1, wherein the preferred quantity of access links for the multi-access PDU session include more than two access links.

10. A network device for wireless communication, comprising:
a memory; and
one or more processors, coupled to the memory, configured to:
select a user equipment (UE) route selection policy (URSP) rule for a UE, wherein the URSP indicates a preference for a multi-access protocol data unit (PDU) session and a preferred quantity and preferred types of access links for the multi-access PDU session; and
transmit the URSP rule to the UE.

11. The network device of claim 10, wherein the URSP rule includes a route selection descriptor component that indicates the preferred quantity and the preferred types of access links for the multi-access PDU session.

12. The network device of claim 11, wherein the route selection descriptor component includes an indication of a multi-access access type option of a plurality of multi-access access type options that are associated with different quantities and types of access links for the multi-access PDU session.

13. The network device of claim 12, wherein the plurality of multi-access access type options includes a first multi-access access type option associated with two 3GPP access links, a second multi-access access type option associated with two non-3GPP access links, a third multi-access access type option associated with three 3GPP access links, a fourth multi-access access type option associated with two 3GPP access links and one non-3GPP access link, a fifth multi-access access type option associated with one 3GPP access link and two non-3GPP access links, and a sixth multi-access access type option associated with three non-3GPP access links.

14. The network device of claim 13, wherein the plurality of multi-access access type options further includes a seventh multi-access access type option associated with one 3GPP access link and one non-3GPP access link.

15. The network device of claim 10, the one or more processors are further configured to:
detect a trigger condition, wherein the one or more processors, to select the URSP rule for the UE, are configured to select the URSP rule for the UE based at least in part on detecting the trigger condition.

16. The network device of claim 10, wherein the preferred types of access links for the multi-access PDU session include multiple 3GPP access links.

17. The network device of claim 10, wherein the preferred types of access links for the multi-access PDU session include multiple non-3GPP access links.

18. The network device of claim 10, wherein the preferred quantity of access links for the multi-access PDU session include more than two access links.

19. A method of wireless communication performed by a user equipment (UE), comprising:
receiving, from a network device, a UE route selection policy (URSP) rule that indicates a preference for a multi-access protocol data unit (PDU) session and a preferred quantity and preferred types of access links for the multi-access PDU session; and
establishing the multi-access PDU session using the preferred quantity and the preferred types of access links indicated by the URSP rule.

20. The method of claim 19, wherein the URSP rule includes a route selection descriptor component that indicates the preferred quantity and the preferred types of access links for the multi-access PDU session.

21. The method of claim 20, wherein the route selection descriptor component includes an indication of a multi-access access type option of a plurality of multi-access access type options that are associated with different quantities and types of access links for the multi-access PDU session.

22. The method of claim 21, wherein the plurality of multi-access access type options includes a first multi-access access type option associated with two 3GPP access links, a second multi-access access type option associated with two non-3GPP access links, a third multi-access access type option associated with three 3GPP access links, a fourth multi-access access type option associated with two 3GPP access links and one non-3GPP access link, a fifth multi-access access type option associated with one 3GPP access link and two non-3GPP access links, and a sixth multi-access access type option associated with three non-3GPP access links.

23. The method of claim 22, wherein the plurality of multi-access access type options further includes a seventh multi-access access type option associated with one 3GPP access link and one non-3GPP access link.

24. The method of claim 19, further comprising:
transmitting, to a base station, a registration request, wherein receiving the URSP rule is based at least in part on transmitting the registration request.

25. A method of wireless communication performed by a network device, comprising:
selecting a user equipment (UE) route selection policy (URSP) rule for a UE, wherein the URSP rule indicates a preference for a multi-access protocol data unit (PDU) session and a preferred quantity and preferred types of access links for the multi-access PDU session; and
transmitting the URSP rule to the UE.

26. The method of claim 25, wherein the URSP rule includes a route selection descriptor component that indicates the preferred quantity and the preferred types of access links for the multi-access PDU session.

27. The method of claim 26, wherein the route selection descriptor component includes an indication of a multi-access access type option of a plurality of multi-access access type options that are associated with different quantities and types of access links for the multi-access PDU session.

28. The method of claim 27, wherein the plurality of multi-access access type options includes a first multi-access access type option associated with two 3GPP access links, a second multi-access access type option associated with two non-3GPP access links, a third multi-access access type option associated with three 3GPP access links, a fourth multi-access access type option associated with two 3GPP access links and one non-3GPP access link, a fifth multi-access access type option associated with one 3GPP access link and two non-3GPP access links, and a sixth multi-access access type option associated with three non-3GPP access links.

29. The method of claim 28, wherein the plurality of multi-access access type options further includes a seventh multi-access access type option associated with one 3GPP access link and one non-3GPP access link.

30. The method of claim 25, further comprising:
detecting a trigger condition, wherein selecting the URSP rule for the UE is based at least in part on detecting the trigger condition.
